(19) United States
(12) Patent Application Publication
(10) Pub. No.: US 2016/0265276 A1
(43) Pub. Date: Sep. 15, 2016

(54) Locking Climbing Stick or Climbing Pole

(71) Applicant: Alex Hartman, Cortland, NY (US)

(72) Inventor: Alex Hartman, Cortland, NY (US)

(21) Appl. No.: 15/053,282

(22) Filed: Feb. 25, 2016

Related U.S. Application Data
(60) Provisional application No. 62/131,294, filed on Mar. 11, 2015.

(51) Int. Cl. E06C 1/38; E06C 1/383; A01M 31/02; E06C 7/48

(52) U.S. Cl. CPC E06C 1/381; E06C 7/48; E06C 1/383; A01M 31/02

(57) ABSTRACT

A climbing stick for climbing upward e.g., to a hunting tree stand, can be locked in a closed position to deter unauthorized persons from climbing on it. A vertical center pole has a plurality of foot pegs are hinged to it at predetermined locations thereon, disposed on the right and left sides of the pole. The foot pegs swing up to a vertical closed position and swing down to a horizontal open position. Left and right vertical side rails are connected by hinges or pivot pins to the ends of the foot pegs on the respective left and right sides. Mating lock fixtures on the left and right vertical side rails allow the left and right vertical side rails be locked when they are closed against one another, and prevent unauthorized access. An extruded aluminum tree hook or jaw assists in mounting the climbing stick against a tree.

This application claims priority of Provisional Application Ser. No. 62/131,294, filed Mar. 11, 2015, now pending, and the contents of which are incorporated herein by reference.

### BACKGROUND OF THE INVENTION

This invention is directed to ladder devices, and in particular to so-called climbing sticks or climbing ladders of the type often attached to a tree for reaching a hunting tree stand that is mounted on the tree. Climbing sticks typically consist of a vertical pole or rail, with horizontal pegs or steps on left and right side of the pole or rail at intervals of perhaps fifteen to sixteen inches. These are often provided in sections with sockets or grommets on one end that fits onto the opposite end of the section above or below, and these normally include a bracket or brace that spaces the climbing stick out from the trunk of the tree and one or more straps or cinches to secure the device onto the trunk of the tree.

A hunter will often place the tree stand (and the ladder or climbing stick) on a tree at a selected hunting location and leave it there for the season. When the hunter is absent, other persons without permission can access the ladder and the tree stand, which can result in theft or in injury if the uninvited person should fall. In order to prevent these events and to prevent the ladder or climbing stick from being an attractive nuisance, it would be desirable to provide the ladder or climbing stick with some means to deny unauthorized access, at least to the lower-most section. However, no suitable means for this exists short of removing the lower section or sections and carrying them off after each use.

### OBJECTS AND SUMMARY OF THE INVENTION

An important object is to provide a ladder or climbing stick that can be locked in a closed position where unauthorized persons could not easily climb on it, and which avoids the drawbacks of the prior art.

It is a related object to make a locking climbing stick or ladder that is of simple construction and without adding undue weight as compared with standard climbing sticks.

As a solution to the foregoing, this invention involves a climbing stick in which the pegs or steps can be all raised to vertical and positioned against the central pole or rail, and locked in this position so that persons will not be able to use the pegs for climbing. This can be applied to the lowest section or sections of the climbing stick or ladder.

The locking climbing stick (or locking section of a climbing stick) has a central vertical pole or rail, which may have a foot or base plate at its lower end to support the pole or rail on the ground. This pole may favorably be about ten feet (or three meters) in height. At intervals on the left and right side are swing-up, swing-down foot pegs that can be disposed vertically against the pole or horizontally to project out from the sides of the central pole. In some cases, the pegs are situated alternately on the left and right from bottom to top, and with a spacing or step distance of about fifteen or sixteen inches, although this is not a critical distance. In other cases, the pegs can be directly opposite at the step distance. The pegs are supported on the center pole with hinge pins, and there are also stop pins to support them when they are in the horizontal position.

There are two side rails also, one on the right and one on the left, and the ends of the foot pegs are attached to the respective side rails with hinge pins. In this way, the foot pegs on each side can be raised by lifting up the respective side rail. There are locking fixtures at the same height on each of the two side rails, so that when the side rails and foot pegs are in the raised position, the two locking fixtures are adjacent one another, and can be secured together e.g. with a padlock. This prevents access to the lowest part of the ladder or climbing stick until the padlock is removed so that the two side rails and the pegs can be lowered to the horizontal, i.e., climbing, position. A lightweight tree hook member is present on the climbing stick to assist in gripping on a tree trunk when a clamp or strap is employed to hold the climbing stick against the tree trunk. This tree hook is favorably a one piece member of extruded aluminum or molded from a tough resin or plastic. A socket or plug or similar fixture at the top of the locking tree climbing stick can mate with a plug or socket at the lower end of a standard climbing stick.

### BRIEF DESCRIPTION OF THE DRAWING

FIG. 1 and FIG. 2 are elevational views of the locking climbing stick according to one embodiment of this invention, in the lowered or open position and in the raised or locked position, respectively.

FIG. 3 and FIG. 4 each show a portion of the embodiment of FIGS. 1 and 2 in the lowered and raised position, respectively.

FIG. 5 shows a portion of the structure of FIG. 4 with a padlock in place.

FIG. 6 is an partial elevation featuring the lower end and base of the climbing stick of this embodiment.

FIG. 7 is a side elevation of two sections of the climbing stick stacked or clamped together for transport.

FIGS. 8 and 9 are a perspective view and a plan or top view of one example of the tree hook/clamp feature, respectively.

FIGS. 10 and 11 are elevational views of the locking climbing stick of this embodiment deployed against a tree trunk between the ground and a tree stand at an elevated position on the tree trunk.

### DETAILED DESCRIPTION OF A PREFERRED EMBODIMENT

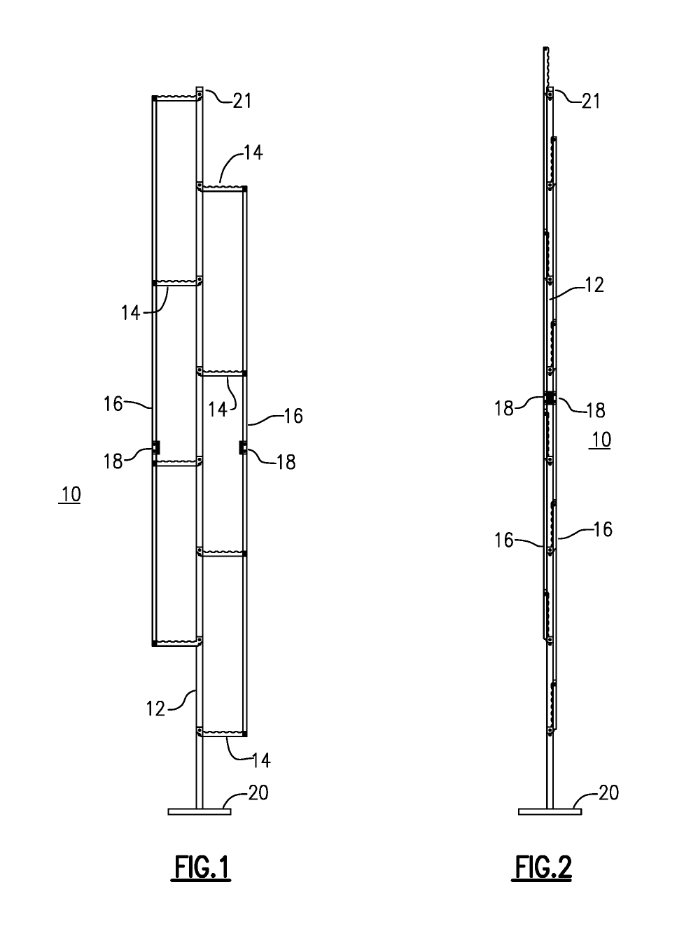

FIGS. 1 and 2 show the climbing stick or center pole ladder 10 according to an embodiment of the invention, in the lowered position for use in climbing, and in the raised position to prevent unauthorized climbing, respectively.

The ladder or climbing stick 10 has a main central pole or rail 12, here about ten feet (three meters) in length, which is disposed vertically for use. There are swing-up foot pegs 14 at intervals on the left and right sides of the central pole 12, with a step height of about fifteen inches. Left and right vertical side rails 16, 16 are connected to the outer ends of the foot pegs 14 on the respective side, using tamper-resistant hardware, and on each side rail there is a lock bracket or fixture 18 at the same height position at each rail so that these will be next to one another when the assembly is in the raised or closed position of FIG. 2.

There is a base plate or footing 20 at the lower end which is configured to rest on the ground at the base of the tree, and an upper tip 21, which can be configured to mate with a socket or ferrule at the lower end of another climbing stick section (not shown here), if desired.

Favorably, the footing 20 can be formed of a tough plastic with a base plate and a post rising from the base plate, and which fits into the hollow lower end of the center pole 12, where it is bolted to permit some rocking motion and to accommodate unevenness in the ground.

While not shown in this view, there may typically be a bow-shaped brace, i.e., tree hook or yoke, to contact the trunk of the associated tree to space and position the assembly securely on the tree trunk and a strap or cinch that extends around the tree trunk to bind the climbing stick 10 to the tree trunk. An example of the tree hook feature will be discussed later.

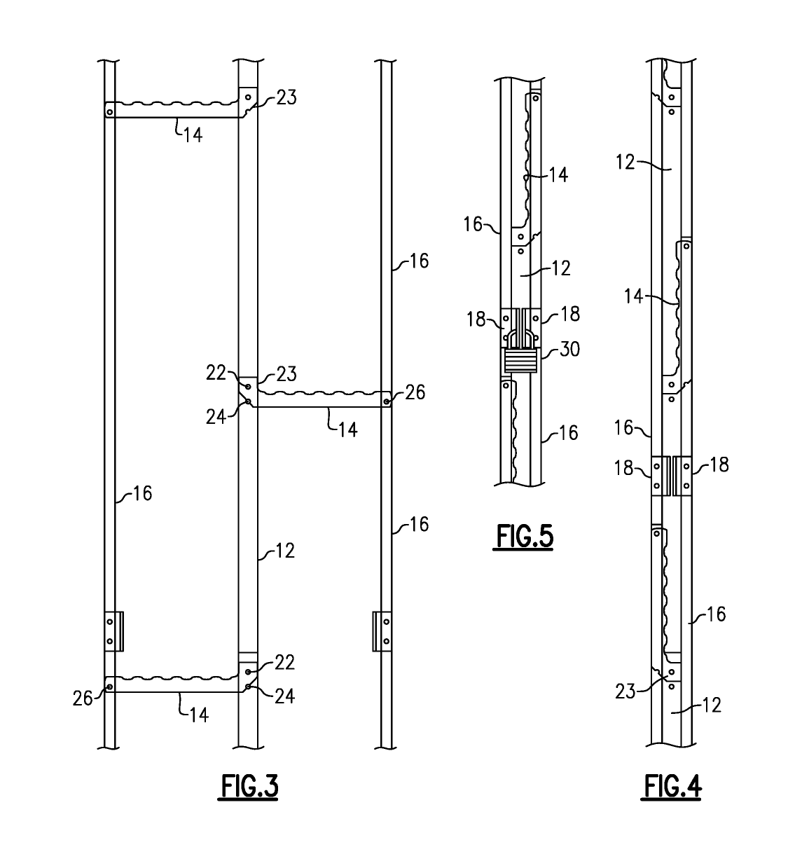

FIGS. 3 and 4 show detail of the climbing stick of this embodiment, including details of the foot pegs 14 and their hinged connections to the center pole 12 and the associated side rails 16. For each foot peg 14 a hinge pin 22 extends through end flanges 23 at the inner end of the step 14 and through the center pole 12, and there is also a stop pin 24 secured in the center pole 14 below the hinge pin 22 and this contacts a diagonal edge of the end flange 23 to block further rotation of the peg when the foot peg is in its horizontal position. For each of the left and right foot pegs 14 there is a hinge pin 26 that extends through the end portion 27 of the respective foot peg 14 and also through the associated side rail 16. In this arrangement, all the foot pegs 14 on each side move together to swing up to the closed position or swing down to the open position. The side rails 16 also provide an additional hand hold for persons climbing this climbing stick. The center pole 12 can be made in two sections, each about five feet long, which connect together with a peg that fits into open ends of each section. This allows the locking climbing stick to be broken down into two half-size lengths for transport or storage. The side rails 16 can each also be in two half-length sections, which can be attached to one another in the field with tamper-resistant bolts or other fasteners.

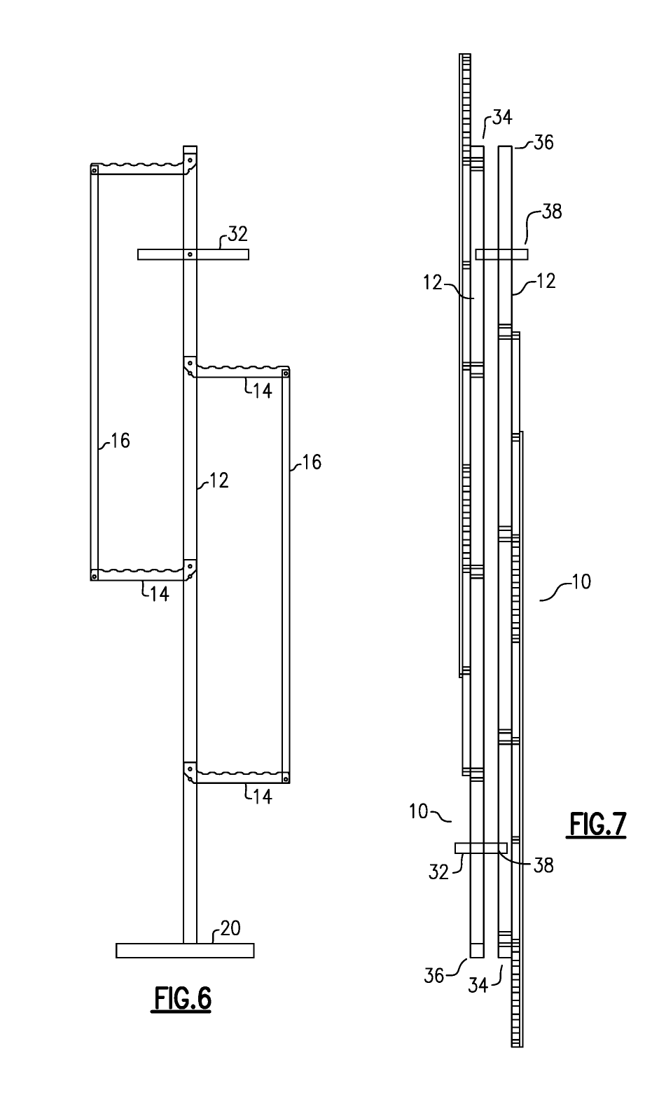

When the climbing stick 10 of this embodiment is placed into the upward or closed position as shown in FIGS. 2 and 4, and in the detail view of FIG. 5, the two lock fixtures 18 are positioned adjacent one another, and this permits the user to lock them to one another, for example by placing the shackle of a padlock 30 through openings in the two fixtures 18. Alternatively, one or the other fixture 18 may incorporate a lock so the fixtures can lock to one another.

FIG. 6 is an elevation showing the lower portion of the climbing stick 10 with the base plate of footing 20, attached at the lower end of the center pole 12. Here a tree hook 32 is positioned partway up the climbing stick, and provides a surface for gripping against a tree trunk when the climbing stick is strapped against the tree.

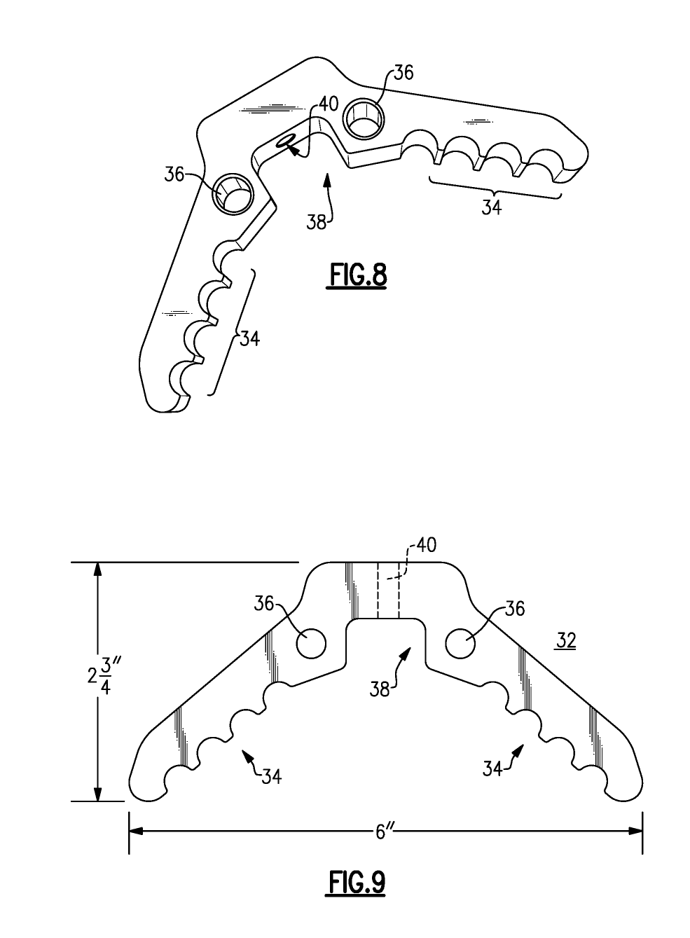

As shown in FIG. 7, two climbing stick sections 10, 10 can be clamped together, with one of the two sections inverted. Portions 38 of the respective tree hooks or yokes 32 can clamp on to the center pole 12 of the other section. This view also shows that each climbing stick section's center pole 12 has a male connecting part 34 at one end and a female connecting part 36 at the other end, so that the two sections can be fitted one on top of the other. As mentioned earlier, the upper sections can omit the locking feature in many applications.

FIGS. 8 and 9 show one example of the tree hook 32, which may be in the form of a jaw, and extruded of heavy-duty aluminum. The tree hook 32 has two projecting jaw members that angle out, each with a row of teeth 34 that can bear against the bark of the tree without damaging it. Also on this are a pair of through-holes or eyes 36 that will accept a strap or bungee cord to help secure the climbing stick to the tree trunk, and a generally square recess 38 that can serve as the portion mentioned above for accepting the center pole of another section or another climbing stick. A bolt hole or post hole 40 extends through a center part of the tree hook and serves for accepting a bolt or post (not shown) to mount the tree hook onto the center pole 12, and allow at least a small amount of swivel so that the teeth 34 of the tree hook 32 can seat against the trunk of the tree.

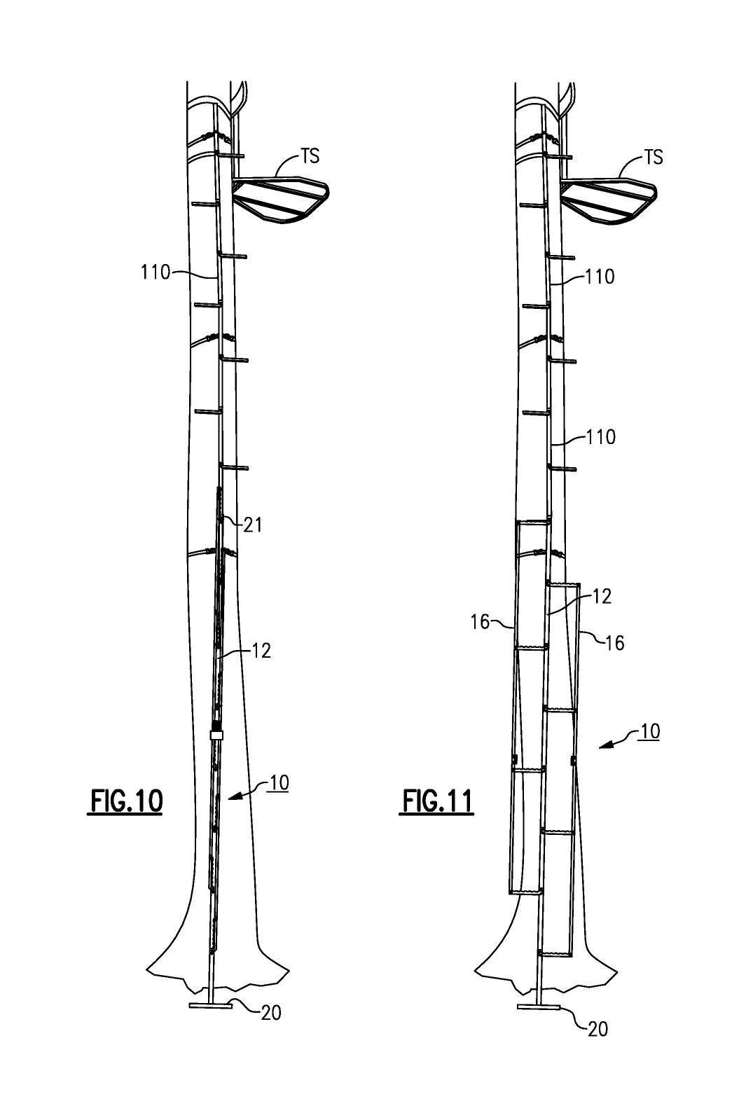

FIGS. 10 and 11 show the climbing stick installed in the field and strapped against a tree, with the base plate 20 against the ground at the base of the tree, and with the locking climbing stick 10 and one or more associated additional non-locking climbing sticks 110 reaching up to a hunter's tree stand TS that is at an elevated position on the tree. FIG. 10 shows the climbing stick 10 in the closed position, while FIG. 11 shows it in the open position.

Many possible modifications and variations of the closeable and lockable climbing stick would occur to persons of skill in the art, without departing from the scope and spirit of the invention, as defined in the claims.

What is claimed is:

1. Climbing stick for climbing upward comprising
a vertical center pole;
a plurality of foot pegs hinged to the vertical center pole at predetermined locations thereon, with the foot pegs disposed at a step interval from one another on the right and left sides of the pole, and each being configured to swing up to a vertical closed position and to swing down to a horizontal open position;
left and right vertical side rails each hingedly connected to the ends of the foot pegs on the respective left and right sides of the vertical center pole; and
mating lock fixtures disposed on the left and right vertical side rails and adapted for securing the left and right vertical side rails to one another when the side rails and foot pegs are in the closed position.

2. The climbing stick of claim 1, comprising hinge pins securing inner end portions of the foot pegs to said center pole and permitting limited rotation of the foot pegs on said center pole.

3. The climbing stick of claim 2, comprising hinge pins attaching outer end portions of said foot pegs to the respective one of said side rails.

4. The climbing stick of claim 1, wherein said vertical center pole includes a stacking feature at an upper end thereof adapted for fitting onto a lower end of a vertical center pole of a similar climbing stick.

5. The climbing stick of claim 1 wherein said mating lock fixtures include a pair of right angle irons that each have one flange affixed onto a respective one of the side rails and have another flange that projects in a forward direction and has an opening therein to receive a shackle of a lock.

6. The climbing stick of claim 1 wherein one of said mating lock fixtures has a lock incorporated therein for locking to the other of said mating lock fixtures.

7. The climbing stick of claim 1 further including at least one tree hook in the form of a jaw having a pair of jaw members angled out from the center pole, and each having a row of teeth formed therein for bearing against the bark of a tree.

8. The climbing stick of claim 7 wherein said tree hook is extruded of heavy-duty aluminum.

9. The climbing stick of claim 7, wherein said tree hook includes a pair of through-holes or eyes formed in each of said jaw arms.

10. The climbing stick of claim 7 wherein said tree hook includes a generally square recess adapted to accept the center pole of another similar section of a climbing stick.

11. The climbing stick of claim 7 wherein a center hole is formed between the two jaw members of said tree hook, adapted to accept a bolt or post that mounts the tree hook onto the center pole, said bolt or post allowing at least a small amount of swivel so that the tree hook can seat against the trunk of the tree.
